(19) United States
(12) Patent Application Publication
(10) Pub. No.: US 2021/0247993 A1
(43) Pub. Date: Aug. 12, 2021

(54) TRUE ZERO RTO ELIMINATING OS AND APP LOAD TIMES

(71) Applicant: EMC IP Holding Company LLC, Hopkinton, MA (US)

(72) Inventors: Jawad Said, Kfar Yasif (IL); Kfir Wolfson, Beer Shave (IL); Jehuda Shemer, Kfar Saba (IL)

(21) Appl. No.: 16/784,078

(22) Filed: Feb. 6, 2020

(51) Int. Cl. G06F 9/455; G06F 9/4401; G06F 3/06

(52) U.S. Cl. CPC G06F 9/45558; G06F 9/4406; G06F 3/065; G06F 3/0653; G06F 2009/45575; G06F 3/0619; G06F 3/067; G06F 3/0683; G06F 2009/45562; G06F 3/0664

(57) ABSTRACT

One example method includes performing a cloning process that includes cloning an OS disk and a data disk of a source VM to create a replica VM having an OS disk and a data disk that correspond, respectively, to the OS disk and data disk of the source VM. A replication process is then performed that includes replicating an application from the data disk of the source VM to the data disk of the replica VM, and the replication process does not include any replication of the OS disk of the source VM to the OS disk of the replica VM. Finally, the replica VM is powered up so that the OS of the replica VM is running, and the application is running on the replica VM. When performing a recovery with the replica VM, the RTO does not include an OS boot time.

### FIELD OF THE INVENTION

Embodiments of the present invention generally relate to data backup and restore processes. More particularly, at least some embodiments of the invention relate to systems, hardware, software, computer-readable media, and methods for reducing the Recovery Time Objective (RTO) of a restore process.

### BACKGROUND

In some backup systems involving virtual machines (VM), IO operations of a production VM may be replicated to a replica VM that may also include applications and an operating system (OS). The replica VM may be in a powered off, or ‘shadow,’ mode in which the OS of the replica VM is not running. While the use of a replica VM is useful in that protection may be afforded to the production VM, the RTO of the replica VM may be unacceptably long. For example, the RTO for the replica VM may include VM OS boot time, which could be several minutes, and application start time, which may be 10s of seconds.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example operating environment for one or more embodiments.

FIG. 2 discloses aspects of an example replication configuration.

FIG. 3 discloses aspects of an example data protection process.

FIG. 4 discloses aspects of an example recovery process.

FIG. 5 discloses aspects of an example computing entity.

### DETAILED DESCRIPTION OF SOME EXAMPLE EMBODIMENTS

Embodiments of the present invention generally relate to data backup and restore processes. More particularly, at least some embodiments of the invention relate to systems, hardware, software, computer-readable media, and methods for reducing the Recovery Time Objective (RTO) of a restore process.

In general, example embodiments of the invention embrace reducing the RTO of a replica system or device, such as a replica VM for example, by eliminating the need to boot the OS of the replica VM. Thus, in example embodiments, the OS boot time is not an element of the RTO of the replica system or device. Put another way, the RTO does not provide for a boot of the OS. Instead, the RTO of the replica VM may comprise, or consist of, the application start time.

In some embodiments, reduction of the RTO by elimination of the OS boot component of the RTO may be achieved by separating the VM disks of the replica. This approach may be effective in various circumstances, such as where the goal is to protect a production application running on the production VM. In some example embodiments, the OS is running on a disk of the replica VM while application data for example, resides on one or more additional VM disks of the replica VM. These additional disks may be protected, such as by way of any-point-in-time (PIT) replication. Since the OS is already running on the replica VM, the RTO for the replica VM is correspondingly reduced by the amount of time that would otherwise be needed to boot the OS of the replica VM. In some embodiments, the protected application may also be running at the replica VM, thus reducing RTO even further.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that RTO for a replica system or device may be significantly reduced. In an embodiment, RTO for a replica system or device is reduced by eliminating the need to boot an OS of the replica system or device. In an embodiment, RTO for a replica system or device is reduced by eliminating the need to start an application of the replica system or device. In an embodiment, RTO for a replica system or device is reduced by eliminating the need to boot an OS of the replica system or device, and by eliminating the need to start an application of the replica system or device. In an embodiment, a reduction in an RTO of a replica system or device enables a system recovery, or failover operation, to be performed relatively more quickly than would otherwise be the case.

A. Aspects of An Example Architecture and Environment

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations. Such data protection operations may include, but are not limited to, data read/write/delete operations, data deduplication operations, data backup operations, data restore operations, data cloning operations, recovery operations, data archiving operations, and disaster recovery operations. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example public cloud storage environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud storage.

In addition to the storage environment, the operating environment may also include one or more clients that are capable of collecting, modifying, and creating, data. As such, a particular client may employ, or otherwise be associated with, one or more instances of each of one or more applications that perform such operations with respect to data.

Devices in the operating environment may take the form of software, physical machines, or virtual machines (VM), or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

As used herein, the term ‘backup’ is intended to be broad in scope. As such, example backups in connection with which embodiments of the invention may be employed include, but are not limited to, full backups, partial backups, clones, snapshots, and incremental or differential backups.

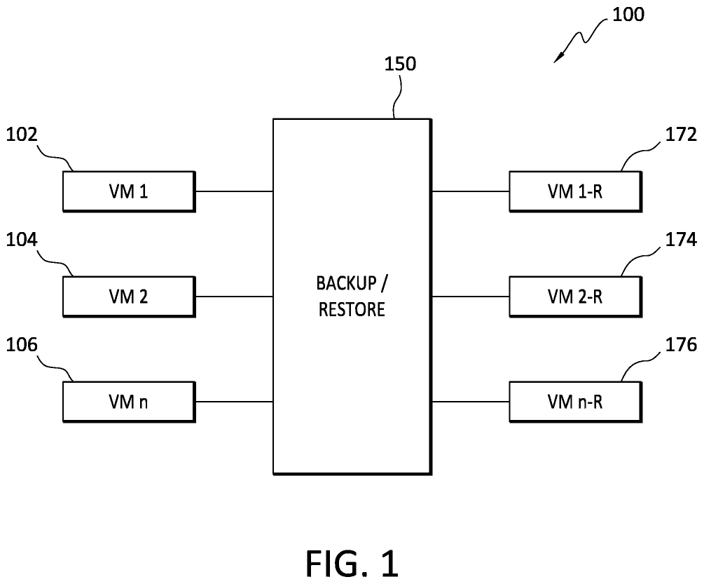

With particular attention now to FIG. 1, one example of an operating environment for embodiments of the invention is denoted generally at 100. In general, the operating environment 100 may include any number ‘n’ of production VMs such as VM1 102, VM2 104, and VMn 106. One or more of the production VMs may run onsite at the premises of an enterprise, or may run in a cloud operating environment. As used herein, ‘production VM’ embraces any VM that is operable to perform one or more functions, such as functions pertaining to the operation of an enterprise, for example. Thus, production VMs may comprise one or more applications that generate new and/or modified data, some or all of which may be protected. Replication is not limited to VM data. The VMs themselves may be protected as well, such as by replication in the form of respective replica VMs. Thus, in the event that a problem were to arise causing the failure of a production VM, the failed production VM can be restored using the corresponding replica VM, or the system may simply failover from the failed VM to the replica VM, which may then function as a production VM.

To facilitate replication of a production VM, the operating environment 100 may include a backup/restore server 150, or other entity, that may cooperate with the production VMs VM1 102, VM2 104, and VMn 106, to create respective replica VMs, namely, VM1-r 172, VM2-r 174, and VMn-r 176. The replica VMs may reside at a cloud storage site and/or any other site, including on-premises at an enterprise for example. The backup/restore server 150 may likewise reside at a cloud storage site, although that is not required. For example, in some embodiments, the backup/restore server 150 may be a standalone system running at a site separate from an enterprise site and a storage site.

Note that the backup/restore server 150 is one example of a replication system. Other entities, or combinations thereof, operable to implement the functionalities disclosed herein, such as the functionalities of the backup/restore server 150 for example, constitute other example implementations of a replication system.

In some embodiments at least, IO operations from the production VMs are replicated, by the backup/restore server 150 for example, to the respective replica VMs in real time as the IOs are written to the production VM disks. To illustrate, a VM any-PIT data protection system such as, for example, RecoverPoint for VMs (RP4VMs), may replicate all IO operations from a production VM to a replica VM. The replica VM disks may be constantly updated with new data written to the production VM disks, and the access to the replica VM disks may be blocked by a software component, such as a splitter in the case of RP4 VMs, in order to avoid inconsistencies and data changing ‘under the feet of’ the OS.

B. RTO—Overview

Data protection is important for organizations. For example, protecting VMs is a key element for organizations using virtualization in their data centers. Generally, organizations would prefer that their Recovery Time Objective (RTO) be as short as possible, that is, is the maximum acceptable amount of time for restoring an application and regaining access to data after an unplanned disruption. Depending upon the circumstances and system configuration, an RTO may involve various processes, which may, or may not, be performed in a particular sequence, as illustrated in the following example:

1. Disk rolling time
a. Restore the replica disk to the chosen PIT.
b. It would typically take a short time (a few seconds) in case the user chose latest image.

2. Hardware configuration
a. Before powering up the replica VM, the replication system brings the hardware to the required configuration according to the production VM
b. Examples: CPU, Memory, Network, etc.
c. It may take 10s of seconds, depending on virtualization infrastructure response time.

3. POST (Power-On Self-Test)
a. POST is the diagnostic testing sequence that a computer runs to determine if the computer hardware is working correctly.

4. OS boot time
a. OS usually takes several minutes depending on OS type, drivers, and hardware.

5. Network discovery and connection
a. Network discovery and connection may take several seconds.

6. Login
a. User login for AD for example, takes several seconds.

7. App start time
a. App may take 10 s of seconds.

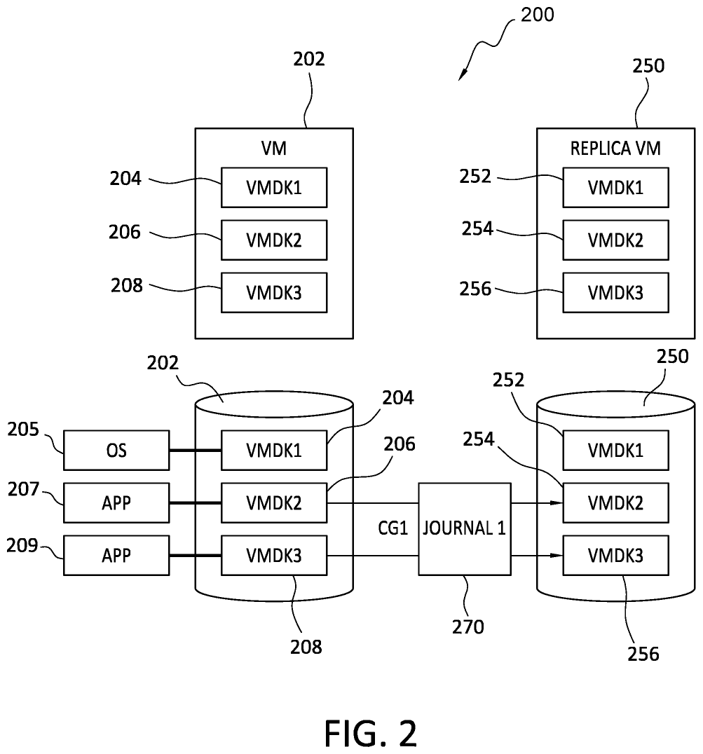

The time required to power up the replica VM and perform the example sequence, that is, the RTO for that replica VM, may be measured in minutes. This may be an unacceptably long time in some circumstances. Accordingly, and with reference now to FIG. 2, the following discussion addresses some example approaches to replicate an entity, such as a VM, so as to reduce the RTO. In general, the example approach disclosed in FIG. 2 involves replicating only non-OS disks of a protected VM, although it should be understood that this approach may be applied, more generally, to other protected entities, and the scope of the invention is not limited to employment of the disclosed methods in connection with VMs. In the example configuration 200 of FIG. 2, the VMDKs are disks that may be employed in VMware implementations.

In general, at least some embodiments of the invention involve the use of a replicated VM that has more than one hard disk. Thus, in the example of FIG. 2, the configuration 200 comprises a VM 202, such as a source or production VM for example, that includes one or more disks, for example, OS disk VMDK1 204, data disk VMDK2 206, and data disk VMDK3 208. In the example of FIG. 2, VMDK1 204 is the OS disk and as such, contains the OS 205 for the VM 202, and VMDK2 206 and VMDK3 208 are data disks that may respectively contain, for example, application data 207 and 209 associated with one or more applications of the VM 202. The executable applications themselves may reside on either VMDK1 204, that is, the OS disk, or on one or more of VMDK2 206 and VMDK3 208, that is, the data disks. One or both of the data disks VMDK2 206 and VMDK3 208 may comprise, for example, a respective file system, or the one or both of the VMDK2 206 and VMDK3 208 data disks may be raw block devices, depending upon the requirements of the VM 202 applications.

With continued reference to FIG. 2, a replica VM 250 is provided that includes a set of disks, where the disks respectively correspond to OS disk VMDK1 204, data disk VMDK2 206, and data disk VMDK3 208 of the source or production VM 202. Particularly, the replica VM 250 includes an OS disk VMDK1 252, data disk VMDK2 254, and data disk VMDK3 256. In general, IOs involving application data 207 and/or 209 of the source VM 202 may be replicated to, respectively, data disk VMDK2 254, and data disk VMDK3 256, of replica VM 250. These IO replication transactions may be captured in a replication journal 270, although that is not required. The replication journal 270 may include a history of IOs written to the data disks of the replica VM 250, and when those IOs were written.

It is noted that while the example of FIG. 2 includes source and replica VMs 202 and 250, respectively, that comprise multiple disks, VMs with only a single disk may be re-configured for employment in connection with embodiments of the invention. For example, a single disk VM may be modified by adding a second disk to the single disk VM, formatting the added disk with a file system, and setting the application data source to reside on the second disk. If needed, a replica VM of the source VM that initially had the single disk configuration may be similarly modified in the event that the replica VM was initially configured with only a single disk.

With continued reference to the example of FIG. 2, a single OS disk 204, 252, respectively, is provided for the source VM 202 and the replica VM 250. In general, the OS and the applications may collectively reside on a predefined fixed number of disks. The disk holding the OS may be defined or tagged as such by the user. Alternatively, the user may define or tag the application disks as such. In some embodiments, a source VM and/or replica VM may each have multiple OS disks.

D. Example Methods—VM Protection Flow

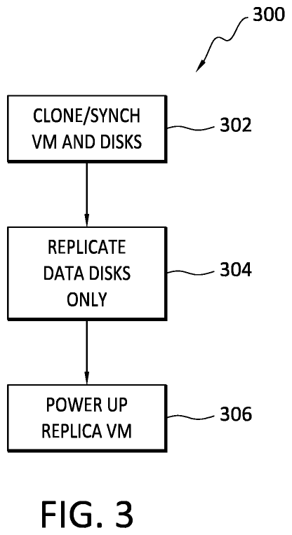

With attention now to FIG. 3, details are provided concerning an example method for protecting data in an environment such as the example operating environment 100 of FIG. 1. One example of such a method is denoted generally at 300 and embraces a VM protection flow. At least some embodiments of the method 300 may be performed by, and/or at the direction of, a replication system such as a backup and restore server, although that is not necessarily required. In some of such embodiments, the backup and restore server, or other replication system, may cooperate with one or more production VMs and a cloud storage site to create one or more replica VMs.

The method 300 may involve a VM, such as a source or production VM for example, that is desired to be protected. Thus, an initial cloning/syncing of the VM and its disks may be performed 302. The initial cloning/syncing 302 may be performed, for example, using the RP4VMs product by DellEMC (https://www.vmware.com/), and replicating the entire VM. In some embodiments, the entire VM may not be replicated however, and only an OS disk and a data disk of the VM may be replicated. In either case, the initial cloning/syncing process 302 results in the creation of a replica VM that is a replica of part, or all, of the source or production VM.

After full synchronization of the VM and disks is completed 302, subsequent data protection processes involving the source or production VM may protect only the data disks 304. For example, an OS of the source VM may not be subjected to any further replication processes, with the result that the OS at the replica VM will remain unchanged after the initial synchronization. Thus, in the particular example of RP4VMs, this means that the OS disk of the source VM will henceforth, that is, after initial synchronization, be unprotected by replication to the replica VM.

The replica VM may then be powered up 306. Only the OS disk of the replica VM will be accessible for use. That is, only the OS disk of the replica VM is up and running at this stage. In order to avoid consistency problems, the data disk(s) of the replica VM may either be disconnected, or remain connected but inaccessible by the OS of the replica VM. In this latter case, access to the data disks of the replica VM may be limited to a splitter, such as the RP4VMs splitter software. After these processes, the replica VM is up and running with only its OS disk, and the source VM data disks are being replicated with any-PIT protection. Note that network connectivity may be handled as well at this stage. Both production and replica VMs are up and running. The replica VM can be connected to production network with a different IP address. This may reduce network configuration time when recovering.

E. Example Methods—VM Recover Flow

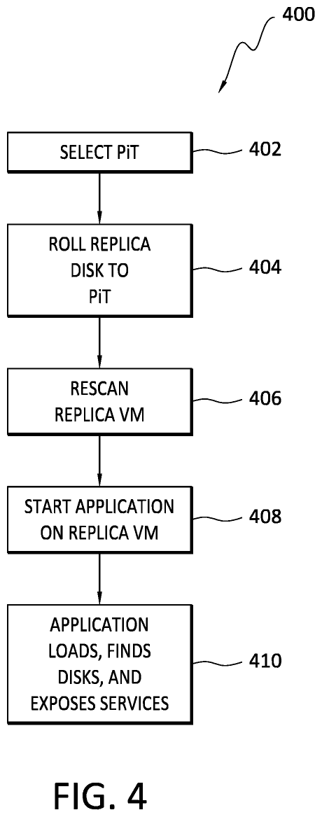

With attention now to FIG. 4, details are provided concerning an example method for restoring a VM using a replica VM, examples of which are disclosed herein. One example of such a method is denoted generally at 400 and embraces a VM recover flow. At least some embodiments of the method 400 may be performed by, and/or at the direction of, a replication system such as a backup and restore server, although that is not necessarily required. In some of such embodiments, the backup and restore server, or other replication system, may cooperate with one or more production VMs and a cloud storage site to restore a VM using a previously created replica VM.

Moreover, in some embodiments, the method 400 may be performed with the replica VM OS, but not the application, already running on the replica VM. In other embodiments, the method 400 may be performed with both the replica VM OS and the application(s) running on the replica VM. The aforementioned application may be, for example, an application that was replicated from the source VM to the replica VM, such as by way of the method 300 for example. While the preceding discussion, and the discussion below, may refer to a singular application, it should be understood that the method 400 may be performed in connection with multiple applications that have been replicated from a source VM to a replica VM.

In the use case where the OS is already running on the replica VM, but the application is not, the application on the replica VM may be powered off if the application is running without any problems on the production VM. Thus, at the replica VM, only the OS is running, while the application at the replica VM is in a state where the application is ready to be started on demand. In some embodiments, the application running on the replica VM may be allowed to continue to run after the restoration process has been completed. In some embodiments, the application on the replica VM may be powered on if not already running and in such embodiments, the powering on of the application on the replica VM may be performed, or not, based on whether or not the application is running on the production VM. For example, if the application on the production VM is not running, the application on the replica VM may be powered up. As another example, if the application on the production VM is running acceptably, the application on the replica VM may be powered off. Finally, in some embodiments the methods 300 and 400 may be performed together as a single method. In these embodiments, a period of time may, or may not, pass between the end of method 300 and the start of method 400.

Turning now to FIG. 4, the method 400 may begin when a user selects, such as by way of a UI for example, a particular PIT 402 to recover a production VM to. For example, if the production VM should fail for some reason, the user may want to recover the production VM to a point in time (PIT) just prior to the failure. More generally however, the production VM may be restored to any desired PIT.

After the PIT has been specified 402, the replication system may use a replication journal to ‘roll’ the data disks of the replica VM, back in time for example, to the desired point in time 404. The replication system may then connect to the rolled replica VM data disks and/or enable access by other entities to the replica VM data disks. More specifically, the replication system may, for example, access the journal and apply one or more IOs from the journal to the replica VM data disks, resulting in a replica VM data disk that is up to date as of the specified PIT. Application of the journal IOs to roll a replica VM data disk back to a specified PIT may involve, for example, reversing, or undoing, any IOs that took place after the specified PIT.

Next, the replication system may initiate a scan, or rescan, 406 on the replica VM, to enable the OS of the replica VM to discover any new disk(s) of the replica VM. As discussed elsewhere herein, there are a variety of ways that the rescan 406 may be performed. When the replica VM disks have been discovered, the replication system may start the application 408 on the replica VM. The application start 408 may be performed, for example, using VMTools and running a shell command. Once started 408, the application may then 410 load on the replica VM, find the preconfigured data disks of the replica VM, and expose its services so that it can be run.

After these operations, the replica VM and the application on the replica VM may be in a disaster recovery (DR) mode, that is, a “DR Test” mode. If failover from the source system/VM is required, the replication system may reverse the replication for the data disks, that is, the replication system may replicate data from the disks of the replica VM to another VM. This reversal may require powering off the application on the production VM, if that VM is still active. Depending upon the application type, the recovered VM IP address may be listed as a production IP (for example, a DNS load balancer). In some embodiments, the total time to run the example recovery operation 400 may be in the 10 s of seconds.

In one variation of the method 400, both the replica VM OS and the replica VM application may already be running prior to the start of the method 400. For example, certain applications, such as Oracle DB Server, may support hot-adding data disks even while the application is already running. Thus, the RTO may be reduced yet further by having the application already loaded and running on the replica VM, such that the application may need only be notified to use the newly discovered disks of the replica VM (see 406 above).

As noted earlier, the process 406 of rescanning the replica VM disks by the replica VM OS and/or the replica VM application may be performed in various ways. In one example, an agent may be provided that runs on the OS of the replica VM, and a dedicated API runs commands against preinstalled software which performs configuration operations on the replica VM. As another example, rescanning 406 may be performed using VMTools or similar software, which may run on the replica VM and can execute system commands on demand. In still another approach to rescanning 406, the replica VM may be subjected to an external STUN process which is a hypervisor action that is similar to a fast suspend/resume of the replica VM. Performance of the STUN process may automatically trigger a rescan of all the disks of the replica VM. Finally, if both the OS and application are already running on the replica VM, a rescan may be performed using an API of the application. After the OS of the replica VM has discovered the replica VM disks, the API may trigger the running application to find the new data disks of the replica VM.

Any of the aforementioned rescan options may be used. The particular approach employed in a given situation may depend, for example, on what the protected application is, and/or the replica VM OS type. The replication system, or user, may choose the best method in order to reduce the RTO of the application.

As disclosed herein then, embodiments of the invention may significantly reduce an RTO for a protected application. For example, and as disclosed herein, such RTO reduction may be obtained in various ways, including, replicating only the important data disks and orchestrating the recovery flows. The OS, and possibly the application, are already running on the replica VM and may ready to recover on demand. Further, RTO may be reduced through selection of a trigger to rescan the replica VM disks. The trigger process may be initiated by the OS of the replica VM and/or the application on the replica VM.

Moreover, embodiments of the invention may eliminate a variety of components that may otherwise contribute to an increase in RTO. Example components whose time impact may be eliminated from RTO by embodiments of the invention include any one or more of the following: hardware configuration (up to 30 seconds in some cases); power-on self-test POST (<5 seconds in some cases); OS boot time (2-5 minutes in some cases; network discovery and connection (˜5 seconds in some cases); and login (˜5 seconds in some cases). Thus, in some embodiments, the RTO for an application at a replica VM may comprise, or consist of, the following elements: disk rolling time (˜30 seconds in some cases); and, application start time (˜10 s of seconds in some cases. Further, if the application is already running at the replica VM, the application start time may be reduced to just a few seconds, or whatever time is needed to rescan the disks at the replica VM.

E. Further Example Embodiments

Following are some further example embodiments of the invention. These are presented only by way of example and are not intended to limit the scope of the invention in any way.

Embodiment 1. A method, comprising: performing a cloning process that comprises cloning an OS disk and a data disk of a source VM to create a replica VM that comprises an OS disk and a data disk that correspond, respectively, to the OS disk and data disk of the source VM; performing a replication process that comprises replicating an application from the data disk of the source VM to the data disk of the replica VM, and the replication process does not include any replication of the OS disk of the source VM to the OS disk of the replica VM; and powering up the replica VM so that the OS of the replica VM is running, and the application is running on the replica VM.

Embodiment 2. The method as recited in embodiment 1, wherein after the replica VM is powered up, the data disk of the replica VM is not accessible to the OS disk of the replica VM.

Embodiment 3. The method as recited in any of embodiments 1-2, further comprising replicating, to the data disk of the replica VM, an IO that was written to the data disk of the source VM.

Embodiment 4. The method as recited in any of embodiments 1-3, further comprising logging the IO in a replication journal.

Embodiment 5. The method as recited in any of embodiments 1-4, further comprising verifying that the source VM is operating correctly, and then powering off, the application that is running on the replica VM.

Embodiment 6. The method as recited in any of embodiments 1-5, wherein after the replica VM is powered up, the application of the source VM is protected by replication to the replica VM, and the OS of the source VM is not protected by replication to the replica VM.

Embodiment 7. The method as recited in any of embodiments 1-6, wherein the cloning process comprises cloning all disks of the source VM to the replica VM.

Embodiment 8. A method comprising: for a replica VM with an OS that is running, receiving an identification of a PIT to recover the replica VM to; using information from a replication journal to roll a data disk of the replica VM to the PIT; rescanning the replica VM to discover a new data disk of the replica VM; determining whether an application on the data disk of the replica VM is running, and if the application is not already running, starting the application; finding, with the application, the new data disk of the replica VM; and exposing, with the application, services which the application is configured to provide.

Embodiment 9. The method as recited in embodiment 8, wherein the rescanning is performed either by an agent of the replica VM OS, or by an API of the application on the replica VM.

Embodiment 10. The method as recited in any of embodiments 8-9, wherein the recited operations collectively define an RTO that does not include a replica VM OS boot time.

Embodiment 11. The method as recited in embodiment 10, wherein when the application on the data disk of the replica VM is already running, the RTO does not include a start time of the application.

Embodiment 12. The method as recited in any of embodiments 8-11, wherein the operations further comprise implementing a failover from a source VM to the replica VM.

Embodiment 13. The method as recited in embodiment 12, wherein the operations further comprise receiving, after the failover is completed, an IO at the replica VM and replicating that IO from the replica VM to another VM.

Embodiment 14. A method for performing any of the operations, methods, or processes, or any portion of any of these, disclosed herein.

Embodiment 15. A non-transitory storage medium having stored therein instructions that are executable by one or more hardware processors to perform the operations of any one or more of embodiments 1 through 14.

F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

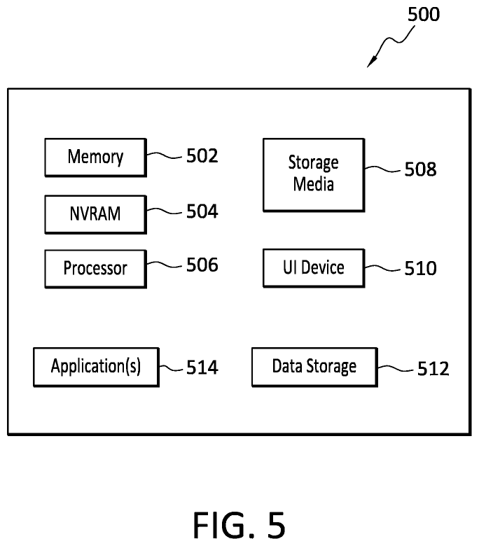

With reference briefly now to FIG. 5, any one or more of the entities disclosed, or implied, by FIGS. 1-4 and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile random access memory (NVRAM) 504, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud storage site, client, datacenter, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
performing a cloning process that comprises cloning an OS disk and a data disk of a source VM to create a replica VM that comprises an OS disk and a data disk that correspond, respectively, to the OS disk and data disk of the source VM;
performing a replication process that comprises replicating an application from the data disk of the source VM to the data disk of the replica VM, and the replication process does not include any replication of the OS disk of the source VM to the OS disk of the replica VM; and
powering up the replica VM so that the OS of the replica VM is running, and the application is running on the replica VM.

2. The method as recited in claim 1, wherein after the replica VM is powered up, the data disk of the replica VM is not accessible to the OS disk of the replica VM.

3. The method as recited in claim 1, further comprising replicating, to the data disk of the replica VM, an IO that was written to the data disk of the source VM.

4. The method as recited in claim 3, further comprising logging the IO in a replication journal.

5. The method as recited in claim 1, further comprising verifying that the source VM is operating correctly, and then powering off the application that is running on the replica VM.

6. The method as recited in claim 1, wherein after the replica VM is powered up, the application of the source VM is protected by replication to the replica VM, and the OS of the source VM is not protected by replication to the replica VM.

7. The method as recited in claim 1, wherein the cloning process comprises cloning all disks of the source VM to the replica VM.

8. A non-transitory storage medium having stored therein instructions that are executable by one or more hardware processors to perform operations comprising:
cloning an OS disk and a data disk of a source VM to create a replica VM that comprises an OS disk and a data disk that correspond, respectively, to the OS disk and data disk of the source VM;
performing a replication process that comprises replicating an application from the data disk of the source VM to the data disk of the replica VM, and the replication process does not include any replication of the OS disk of the source VM to the OS disk of the replica VM; and
powering up the replica VM so that the OS of the replica VM is running, and the application is running on the replica VM.

9. The non-transitory storage medium as recited in claim 8, wherein after the replica VM is powered up, the data disk of the replica VM is not accessible to the OS disk of the replica VM.

10. The non-transitory storage medium as recited in claim 8, further comprising replicating, to the data disk of the replica VM, an IO that was written to the data disk of the source VM.

11. The non-transitory storage medium as recited in claim 8, further comprising logging the IO in a replication journal.

12. The non-transitory storage medium as recited in claim 8, further comprising verifying that the source VM is operating correctly, and then powering off the application that is running on the replica VM.

13. The non-transitory storage medium as recited in claim 8, wherein after the replica VM is powered up, the application of the source VM is protected by replication to the replica VM, and the OS of the source VM is not protected by replication to the replica VM.

14. The non-transitory storage medium as recited in claim 8, wherein the cloning process comprises cloning all disks of the source VM to the replica VM.

15. A non-transitory storage medium having stored therein instructions that are executable by one or more hardware processors to perform operations comprising:
for a replica VM with an OS that is running, receiving an identification of a PIT to recover the replica VM to;
using information from a replication journal to roll a data disk of the replica VM to the PIT;
rescanning the replica VM to discover a new data disk of the replica VM;
determining whether an application on the data disk of the replica VM is running, and if the application is not already running, starting the application;
finding, with the application, the new data disk of the replica VM; and
exposing, with the application, services which the application is configured to provide.

16. The non-transitory storage medium as recited in claim 15, wherein the rescanning is performed either by an agent of the replica VM OS, or by an API of the application on the replica VM.

17. The non-transitory storage medium as recited in claim 15, wherein the recited operations collectively define an RTO that does not include a replica VM OS boot time.

18. The non-transitory storage medium as recited in claim 17, wherein when the application on the data disk of the replica VM is already running, the RTO does not include a start time of the application.

19. The non-transitory storage medium as recited in claim 15, wherein the operations further comprise implementing a failover from a source VM to the replica VM.

20. The non-transitory storage medium as recited in claim 19, wherein the operations further comprise receiving, after the failover is completed, an IO at the replica VM and replicating that IO from the replica VM to another VM.
